(19) United States
(12) Patent Application Publication
(10) Pub. No.: US 2009/0299569 A1
(43) Pub. Date: Dec. 3, 2009

(54) Apparatrus for assisting driving of a vehicle and method for operating the apparatus

(76) Inventors: Peter Knoll, Ettlingen (DE); Hans-Peter Grabsch, Boeblingen (DE); Uwe Beutnagel-Buchner, Stuttgart (DE); Werner Uhler, Bruchsal (DE); Arnd Engeln, Tuebingen (DE); Jan Egelhaaf, Leonberg (DE); Marc Arnon, Leonberg (DE); Markus Rossmeier, Benndorf (DE); Michael Dorna, Bietigheim-Bissingen (DE); Sebastian Enders, Stuttgart (DE)

Correspondence Address: KENYON & KENYON LLP, ONE BROADWAY, NEW YORK, NY, 10004, US

(21) Appl. No.: 11/921,637

(22) PCT Filed: May 10, 2006
(86) PCT No.: PCT/EP2006/062184

§ 371 Date: May 26, 2009

(30) Foreign Application Priority Data
Jun. 24, 2005 (DE) 10 2005 029 444.8

(51) Int. Cl. G06F 7/00

(52) U.S. Cl. 701/36

(57) ABSTRACT

An apparatus is described for assisting driving of a vehicle having at least two driver assistance systems and having an output device or element for communicating information items of at least one of the driver assistance systems to a driver of the vehicle. To relieve the strain on the driver, a control device or element, configured as an information coordinator and connected at its input side to the driver assistance systems and at its output side to the output device is provided for controlling information items of the driver assistance systems to be communicated to the driver.

### FIELD OF THE INVENTION

The present invention relates to an apparatus for assisting driving of a vehicle having at least two driver assistance systems and having an output device for communicating information of at least one of the driver assistance systems to a driver of the vehicle. The present invention further relates to a method for operating such an apparatus.

### BACKGROUND INFORMATION

Driver assistance systems (DAS) are being increasingly used, especially in motor vehicles, to assist the driver. This may involve, on the one hand, provision of driver assistance systems that take on aspects of the driver's tasks and where applicable inform him, for example, about driving states and, on the other hand, provision of driver assistance systems that merely inform the driver, for example, when a possibly incorrect action on the part of the driver is detected.

The various driver assistance systems are installed in the vehicle independently of one another and usually operate with their own sensors and control units. Each of the driver assistance systems uses its own output device for communicating advice to the driver. Even when only two driver assistance systems are used in parallel in the vehicle, the outputting of advice of the different driver assistance systems in what might moreover be close succession may lead, at any rate temporarily, to increased strain on the driver.

### SUMMARY

One object of the present invention is to provide an apparatus that further relieves the strain on the driver when driving the vehicle, while unrestricted assistance of the driver by the driver assistance systems is maintained. A further object of the present invention is to give a method for operating such an apparatus.

The first aforementioned object may be achieved according to an example embodiment of the present invention with an apparatus of the kind described in the introduction by virtue of the fact that a control device or element, configured as an information coordinator and connected at its input side to the driver assistance systems and at its output side to the output device or element, is provided for controlling information items of the driver assistance systems to be communicated to the driver.

The second aforementioned object may also be achieved in accordance with an example embodiment of the present invention with a method of the kind described in the introduction by virtue of the fact that, upon arrival in the control device of an information item of one of the driver assistance systems which is to be communicated to the driver and upon simultaneous indication by the prediction means of an information item of another of the driver assistance systems which is to be expected with a predetermined probability and/or upon simultaneous indication of an information item of another of the driver assistance systems, which is to be expected with a given probability, by that other driver assistance system itself, the control device performs information combination to produce an overall information item and the overall information item is forwarded to the output device.

Example embodiments of the present invention accordingly provide an information coordinator which coordinates information items from driver assistance systems operating per se independently of one another in a vehicle, especially in a motor vehicle, so that the various information items are communicated to the driver in a mutually coordinated manner. The information items may in general be, for example, reports, messages, measured values or data, the information items being transmitted in the apparatus of the present invention in the form of signals, that is to say, in a physical representation; an information item is formed by at least one signal. The present invention is particularly advantageous when the information items are warnings which are to be communicated to the driver and to which he regularly has to react. Using the present invention, the communication and outputting of numerous information items, especially warnings, to the driver in only a very short space of time, which would mean a high strain on him, may advantageously be avoided. At the same time, by the use of the information coordinator—in contrast to simple suppression of information items, which would also be possible—information loss is reliably avoided. Accordingly, the driver may be given at all times the full assistance of the driver assistance systems present in his vehicle. Using the information coordinator, the number of individual occurrences of information outputs to the driver may be reduced. This may be done, for example, in a form such that generalized advice combining the respective information items of individual driver assistance systems into one announcement may be output to the driver; the information content of individual information outputs increases in such a case. The driver is thereby able to react to the announcements calmly and relatively extensively and apply any necessary corrective measures to drive the vehicle. Further examples of a reduction in the number of individual occurrences of information outputs to the driver which is made possible by the present invention may be prioritization of information items, suppression of information items (for example information items non-essential to driving safety), delaying of information items or resolution of (apparently or actually) conflicting items of information. The apparatus according to the present invention makes possible additionally increased concentration of the driver on what is happening in the traffic, whereby it is possible to achieve not only enhanced driving safety of the driver's own vehicle but also enhanced traffic safety overall. The present invention, which makes it possible, in particular, to coordinate current warnings and foreseeable warnings, may be especially suitable for private cars and equally for commercial vehicles. Warnings that are superfluous to the driver but which demand his attention may be reliably avoided with the present invention. The driver assistance systems advantageously do not have their own interface with the driver, but rather information items of the driver assistance systems are communicated to the driver exclusively via the information coordinator. The information items to be communicated to the driver are generally operating parameters of the apparatus; input parameters of the information coordinator are especially those output parameters of the driver assistance systems that are important for triggering a warning. With the aid of the information coordinator according to the present invention hazardous situations may advantageously be averted and conflicts in the communication of information to the driver may be resolved. With regard to the method according to the present invention, it might be imagined that, rather than an information item that is to be expected being predicted, information items of the driver assistance systems arriving in the information coordinator within a time window, for example, are combined and forwarded to the driver. However, the information combination proposed in accordance with the present invention, which takes a prediction into consideration especially in the case of information items in the form of warnings, is by comparison very advantageous, since above all a delayed forwarding of warnings to the driver—which might have safety implications—is thereby avoided. In the same way as the predictions of the prediction device or element relate to information items of the driver assistance systems that are to be expected, they may, where applicable, also relate to information items of a driver information system and/or of a vehicle sensor. It is possible for probabilities starting at which information items are taken into consideration for the information combination to be stored in the apparatus according to the present invention, for example, in a memory outside the information coordinator. However, an advantageous form of the method is one whereby either the information coordinator determines the respective probability itself (determined probability), that is to say, the prediction device of the information coordinator indicates the information items with a predetermined probability, or the respective probability is communicated to the information coordinator by the relevant driver assistance system, that is to say, that driver assistance system itself indicates an information item together with a given probability regarding an expected actual happening of an event corresponding to the information item; the latter means that the method is also able to consider probability values that are transmitted to the control device together with an information item. Advantageously, it may be provided that, prior to outputting of the overall information item to the driver, an advance information item, especially an advance warning, is communicated to the driver.

For an especially simple construction of the apparatus according to the present invention, it may be advantageous if the control device combines a first information item arriving from a first of the driver assistance systems and a second information item arriving from a second of the driver assistance systems and forwards the overall information item to the output device. Accordingly, the control device is suitable for combining a first information item received in the control device and a second information item received in the control device to produce a new information item forming the overall information item and for forwarding that overall information item, resulting from the two individual information items, to the output device. It may be provided both that information items arriving in the control device simultaneously are taken into consideration for the overall information item and that information items arriving in the control device within a specific, optionally adjustable, time window are taken into consideration for the overall information item.

It may be particularly advantageous if the control device is connected at its input side to at least one driver information system and/or directly to at least one vehicle sensor. It may be thereby possible for the strain on the driver to be additionally relieved by virtue of the fact that not only information items from driver assistance systems that are to be communicated to him but also those from driver information systems (DIS) and/or from sensors communicating directly with the driver, which sensors may also involve a sensor device including a plurality of sensors, are coordinated with one another and forwarded to the driver by the information coordinator. Examples of driver information systems are navigation devices, rain sensors and light sensors; the expression “driver information systems” is to be understood in general terms and may preferably also include entertainment and/or information and/or communication device or element, such as, for example, an entertainment system or a radio with traffic congestion announcements (known by the name Traffic Message Channel (TMC)) or a telephone. Examples of vehicle sensors are those which measure accelerator pedal position, brake pedal position or steering angle.

If the control device advantageously has a decision device or element for indicating information items of at least the driver assistance systems that are to be forwarded to the output device, in an especially simple manner it is possible with the aid of the decision device to make use of, for example, data on possible driving conditions and/or on a current journey which are stored in the control device, especially in the decision device, and on that basis coordinate the information items with the result of an indication of the information item that is to be forwarded by the control device to the output device at the particular time.

Advantageously, the control device has a prediction device or element for indicating information items of at least the driver assistance systems that are to be expected, so that the information coordinator is able to take information items that have not yet arisen but which are to be expected with a high probability into account for information coordination and forwarding to the driver. In that manner, even more specifically targeted information communication to the driver may take place. Using a prediction, especially of warnings, it is possible to prepare safety systems even before the occurrence of the actual warning event and thereby shorten a reaction time which is inherent in the system, thereby increasing driving safety as a whole.

Furthermore, it is particularly advantageous for the control device to have a memory containing driving situations that are to be expected and which are based, for example, on data already entered in principle in the memory and/or on data of previous journeys, and for the memory to be connected upstream of the prediction device. On the basis of typical driving situations and classification of the actual journey into one of those driving situations, it is possible for the prediction accuracy of the prediction device to be further increased.

For clear outputting of information items to the driver it is advantageous for the output device to have at least one optical output element, especially a display screen, and/or at least one acoustic output element, especially a loudspeaker, and/or at least one haptic output element, that is to say a device appealing to the driver's sense of touch, such as, for example, a vibration device.

The output device preferably has at least two output elements, the outputs of which are each perceptible by a different human sense. This means that, for example, both an optical output element and a haptic output element are present. The two output elements may be used both together and selectively for information output to the driver, depending on the individual case.

It is advantageous for an output coordinator for controlling information items forwarded by the control device to the output device to be disposed between the control device and the output device. The output coordinator is able to adapt the information items forwarded to the driver by the information coordinator to the requirements of the driver and, for example, select a respectively suitable output element from a plurality of output elements and use it for outputting information to the driver.

Component integration in the example apparatus according to the present invention is advantageously enhanced when the output device has, connected upstream of the output elements, an output coordinator for controlling information items forwarded by the control device to the output device.

The example apparatus according to the present invention may be used particularly effectively when the driver assistance systems include an adaptive cruise control (ACC) driver assistance system, and/or a lane departure warning (LDW) driver assistance system and/or a lane change assist (LCA) driver assistance system.

It may be particularly advantageous for the control device to associate information items of the driver assistance systems arriving in the control device with a driver situation from among a plurality of driving situations that are to be expected and which are stored in the memory, and for the associated driving situation to be taken into consideration for the information combination. In that manner, the information coordinator is able to operate especially quickly and reliably.

### BRIEF DESCRIPTION OF THE DRAWINGS

Exemplary embodiments of the present invention are shown schematically in the figures and are described in detail below.

FIG. 1 shows an apparatus for assisting driving of a vehicle.

FIG. 2 shows a further apparatus for assisting driving of a vehicle.

### DESCRIPTION OF EXAMPLE EMBODIMENTS

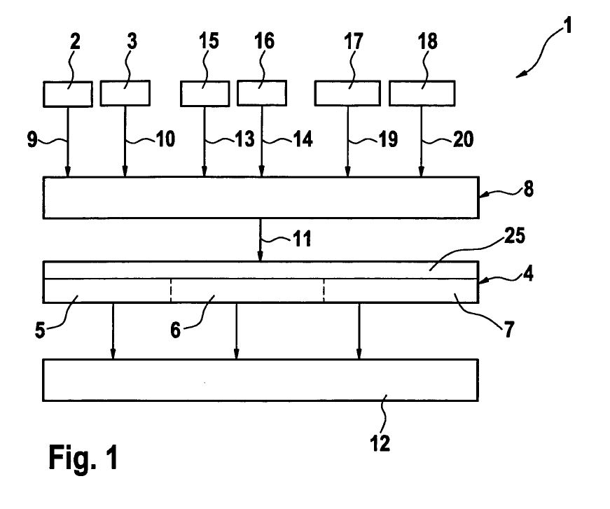

FIG. 1 shows in a simplified diagram an apparatus 1 for assisting driving of a motor vehicle. Apparatus 1 is installed in the motor vehicle, not shown here, and has two driver assistance systems 2, 3. In addition, an output device or element 4 is provided, with the aid of which information items, and especially warnings, are communicated to a driver 12 of the motor vehicle. Output device 4 has an optical output element 5 with a display screen, an acoustic output element 6 with a loudspeaker and a haptic output element 7 with a vibration device arranged, for example, on a rim of a steering wheel of the motor vehicle, so that three different senses of the driver, namely sight, hearing and touch, may be appealed to by outputs of output device 4 representing information items to be communicated to the driver.

Disposed between output device 4 and driver assistance systems 2, 3 is a control device 8 configured as an information coordinator which is connected at its input side via data lines 9, 10 to driver assistance systems 2, 3 and at its output side via a data line 11 to output device 4. Via respective further data lines 13, 14 for transmission of information items, two driver information systems 15, 16 are additionally connected to control device 8. In addition, by way of example two sensors 17, 18 are connected to the input of control device 8 via respective data lines 19, 20 provided for information transmission. The data lines 9, 10, 11, 13, 14, 19, 20 may in general also be, for example, radio links or channels on a bus system.

Output device 4 has, connected upstream of output elements 5, 6, 7, an output coordinator 25 for controlling information items forwarded by control device 8 to output device 4; output coordinator 25 allocates the aforementioned information items to an individual output element of output elements 5, 6, 7 or to a group of output elements.

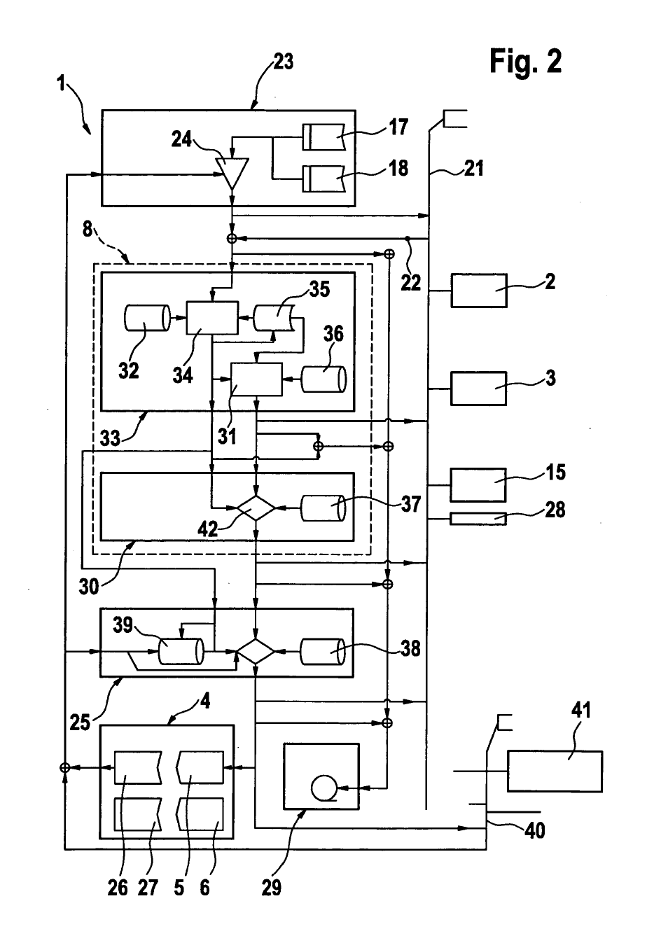

Another apparatus 1 for assisting driving of a motor vehicle is shown in a simplified diagram in FIG. 2, wherein the same reference numerals as those in the exemplary embodiment shown in FIG. 1 are used for corresponding elements.

Apparatus 1 has three driver assistance systems 2, 3, 28, more specifically a first driver assistance system 2 configured as an ACC driver assistance system, a second driver assistance system 3 configured as an LDW driver assistance system, and a third driver assistance system 28 configured as an LCA driver assistance system, and a driver information system 15 which are connected to a common bus data line 21 of a data bus. Bus data line 21 is connected via a data line 22 to the input of a control device 8 configured as an information coordinator. In addition, control device 8 is connected at its input side directly to a sensor device 23 having two vehicle sensors 17, 18 the information items of which are communicated to control device 8 following sensor data fusion in a mixing element 24 of sensor device 23.

At its output side, control device 8 is connected to an output device 4, generally configured as a man-machine interface (MMI), output device 4 having in this exemplary embodiment input elements 26, 27 as well as output elements 5, 6. Disposed between control device 8 and output device 4 is an output coordinator 25, configured as an MMI manager, for controlling information items forwarded by control device 8 to output device 4.

Control device 8 is furthermore connected at its output side to a recording device 29. Control device 8 has a decision device or element 30 for indicating information items, especially warnings, of driver assistance systems 2, 3, 28, driver information system 15 and vehicle sensors 17, 18 that are to be forwarded to output device 4. In addition, control device 8 has a prediction device or element 31 for indicating information items of driver assistance systems 2, 3, 28, driver information system 15 and vehicle sensors 17, 18 that are to be expected. Connected upstream of prediction device 31 is a memory 32 of control device 8, in which memory 32 driving situations of the motor vehicle that are to be expected are stored.

Prediction device 31 is a component part of a driving situation interpreting device 33 of control device 8, driving situation interpreting device 33 also including a driving situation processor 34, a history data memory 35, in which a previous course of a current journey of the motor vehicle is stored, and a rule data memory 36. Decision device 30 and output coordinator 25, which, in addition, has a user profile memory 39, are also each provided with a respective rule data memory 37, 38. Rule data memories 36, 37, 38 preferably contain rules of the artificial intelligence.

Apparatus 1 for assisting driving of the motor vehicle is linked to a bus data line 40 of a data bus belonging to an entertainment system 41.

Upon arrival in control device 8 of an information item of one of driver assistance systems 2, 3, 28, driver information system 15 or driver sensors 17, 18 which is to be communicated to the driver and upon simultaneous indication by prediction device 31 of control device 8 of an information item of another device of the aforementioned driver assistance systems 2, 3, 28, driver information system 15 or vehicle sensors 17, 18, which information item is to be expected with a predetermined probability, information combination to produce an overall information item is performed with a combining element 42 of decision device 30 of control device 8. Preferably, prediction device 31 may continuously indicate information items that are to be expected, the further consideration of which may depend on the probability of their happening.

The overall information item leaving combining element 42 is forwarded to output device 4. For the information combination, there is taken into consideration an associated driving situation which is obtained by virtue of the fact that control device 8, using situation interpreting device or element 33, associates information items of driver assistance systems 2, 3, 28, driver information system 15 or vehicle sensors 17, 18, arriving in control device 8, with a driving situation from among a plurality of driving situations that are to be expected and which are stored in memory 32.

Situation interpreting device 33 indicates with a predetermined probability the actual existence of a certain driving situation and, with the aid of prediction device 31, it makes a prediction regarding an occurrence of a certain driving situation which is to be expected with a predetermined probability. That indication and prediction are taken into consideration by decision device 30.

1-13. (canceled)

14. An apparatus for assisting driving of a vehicle having at least two driver assistance systems and having an output device for communicating information items of at least one of the driver assistance systems to a driver of the vehicle, the apparatus comprising:
a control device, configured as an information coordinator and connected at its input side to the driver assistance systems and at its output side to the output device, the control device adapted to control information items of the driver assistance systems to be communicated to the driver.

15. The apparatus as recited in claim 14, wherein the control device is adapted to combine a first information item arriving from a first of the driver assistance systems and a second information item arriving from a second of the driver assistance systems to produce an overall information item and to forward the overall information item to the output device.

16. The apparatus as recited in claim 14, wherein the control device is connected at its input side to at least one of: i) at least one driver information system, and ii) directly to at least one vehicle sensor.

17. The apparatus as recited in claim 14, wherein the control device includes a decision element adapted to indicate information items of at least the driver assistance systems that are to be forwarded to the output device.

18. The apparatus as recited in claim 14, wherein the control device includes a prediction element for indicating information items of at least the driver assistance systems that are to be expected.

19. The apparatus as recited in claim 18, wherein the control device has a memory containing driving situations that are to be expected, and the memory is connected upstream of the prediction element.

20. The apparatus as recited in claim 14, wherein the output device includes at least one of an optical output element, an acoustic output element, and a haptic output element.

21. The apparatus as recited in claim 20, wherein the output device includes at least two output elements, outputs of which are each perceptible by a different human sense.

22. The apparatus as recited in claim 20, wherein an output coordinator adapted to control information items forwarded by the control device to the output device is disposed between the control device and the output device.

23. The apparatus as recited in claim 21, wherein the output device has, connected upstream of the output elements, an output coordinator adapted to control information items forwarded by the control device to the output device.

24. The apparatus as recited in claim 14, wherein the driver assistance systems include at least one of an adaptive cruise control driver assistance system, a lane departure warning driver assistance system, and a lane change assist driver assistance system.

25. A method for assisting driving of a vehicle having at least two driver assistance systems, comprising:
receiving, by a control device, an information item of one of the driver assistance systems which is to be communicated to the driver;
simultaneously receiving an indication by a prediction device of an information item of another of the driver assistance systems which is to be expected with a predetermined probability;
performing, by the control device, an information combination based on the information item of one of the driver assistance systems and the information item of the other of the driver assistance systems, to produce an overall information item; and
forwarding the overall information item to an output device.

26. A method for assisting driving of a vehicle having at least two driver assistance systems, comprising:
receiving, by a control device, an information item of one of the driver assistance systems which is to be communicated to a driver;
simultaneously receiving an indication of an information item of another of the driver assistance systems which is to be expected with a predetermined probability;
performing, by the control device, an information combination based on the information item of one of the driver assistance systems and the information item of the other of the driver assistance systems, to produce an overall information item; and
forwarding the overall information item to an output device.

27. The method as recited in claim 25, further comprising:
associating, by the control device, information items of the driver assistance systems arriving in the control device with a driving situation from among a plurality of driving situations that are to be expected and which are stored in a memory, the associated driving situation being taken into consideration for the information combination.
